(19) United States
(12) Patent Application Publication
(10) Pub. No.: US 2024/0155026 A1
(43) Pub. Date: May 9, 2024

(54) GREEN LOAD BALANCING IN GLOBAL LOAD BALANCING DEPLOYMENTS

(71) Applicant: VMware LLC, Palo Alto, CA (US)

(72) Inventors: RAJAGOPAL SREENIVASAN, Bangalore (IN); Sreeram Iyer, Bangalore (IN); Benjamin L. Pfaff, Redwood City, CA (US); Victor Firoiu, Westford, MA (US); Diptyaroop Maji, Amherst, MA (US)

(21) Appl. No.: 18/095,014

(22) Filed: Jan. 10, 2023

(30) Foreign Application Priority Data
Nov. 4, 2022 (IN) 202241063100

(51) Int. Cl. H04L 67/1012

(52) U.S. Cl. CPC H04L 67/1012

(57) ABSTRACT

The disclosure provides an approach for load balancing requests among data centers based on one or more environmental impact factors of the data centers. A method of load balancing requests among data centers is provided. The method includes receiving, at a load balancer from a client, a service request. The method further includes selecting, by the load balancer, a first data center of a plurality of data centers based on one or more environmental impact factors associated with each of the plurality of data centers. The method further includes causing the service request to be serviced by the selected first data center.

### RELATED APPLICATIONS

Benefit is claimed under 35 U.S.C. 119(a)-(d) to Foreign Application Serial No. 202241063100 filed in India entitled “GREEN LOAD BALANCING IN GLOBAL LOAD BALANCING DEPLOYMENTS”, on Nov. 4, 2022, by VMware, Inc., which is herein incorporated in its entirety by reference for all purposes.

### BACKGROUND

Global Server Load Balancing (GSLB) based on Domain Name System (DNS) is a technology used in modern day data centers. GSLB allows a service provider to distribute workloads across multiple data centers. A load balancing function allows DNS requests or queries to be resolved to different workloads/servers in different data centers. As a result, GSLB facilitates reduced latencies and network traffic by directing traffic to geographically proximal data centers, more evenly distributed traffic across data centers, and business continuity and disaster recovery in the case of a failure or fault at a datacenter. GSLB devices can be deployed within multiple different data centers and registered with an upper-level DNS server. The GSLB devices can resolve DNS queries (e.g., by returning the IP address of a selected data center) based on defined load-balancing policies.

### BRIEF DESCRIPTION OF THE DRAWINGS

FIG. 1 is an illustration of example network components with which embodiments of the present disclosure may be implemented.

FIG. 2 depicts example operations related to green load balancing across data centers and/or servers.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure provides an approach for load balancing of requests across data centers based on one or more environmental impact factors (also referred to as green factors). For example, certain aspects relate to load balancing client requests for services to data centers, or even particular servers within data centers based at least in part on one or more environmental impact factors. For example, a load balancer may receive any suitable request from a client. There may be a number of different data centers in different geographical regions that are configured to service the request, such as running workloads on servers configured to handle the request. The load balancer may select which data center (e.g., which server in a particular data center) to service the request based at least in part on the one or more environmental impact factors, and cause the request to be serviced by the selected data center (e.g., selected server in the data center). For example, the load balancer may provide to the client an address (e.g., IP address) of a server in the data center to allow the client to initiate communication with the server in the data center to service the request. As another example, the load balancer may forward the request to the selected server in the data center along with an address of the client, and the selected server may initiate communication with the client to service the request.

The one or more environmental impact factors may include a carbon intensity (CI) associated with a data center or server, which may be an amount of carbon emitted per unit of electricity generated by the sources in the power grid that powers the data center or server. For example, different renewable and non-renewable sources, such as coal, solar, wind, hydro, nuclear, etc., may have different carbon footprints.

In certain aspects, the CI taken into account may be a marginal CI, which may be an amount of carbon emitted per unit of electricity generated by the sources in the power grid when an additional load is added to the grid. Additionally or alternatively, in certain aspects, the CI taken into account may be an average CI, which may be an average amount of carbon emitted per unit of electricity generated by the sources in the power grid over a particular time period (e.g., the last 5 minutes). CI, including marginal CI and average CI may vary both spatially based on geographical location of the data center (e.g., server in the data center), and temporally, such as energy sources change over time as new power plants are built or decommissioned, or as the overall load on a given energy source changes.

It should be noted that CI is just one example of an environmental impact factor, and that any suitable parameter for measuring the green-ness of a region may be used. Such information regarding environmental impact factors of a geographical region may be provided by various different organizations, such as in the form of watttime, electricity maps, etc. Additional examples of such environmental impact factors may include non-carbon pollutants produced from power generation such as nitrogen oxides, sulfuric oxides, organic pollutants, or even thermal pollution of waterways derived from nuclear plant cooling. In addition to the pollution directly resulting from electrical power generation, a contribution to greenhouse gases and/or other pollutants resulting from indirect effects may be examples of environmental impact factors, including the transportation of fuel to the power plant, usage of batteries for storing backup power, the construction and maintenance, and eventual decommissioning of the power plant, the disposal and/or storing of waste products, and so forth. Different environmental impact factors may be combined into an overall score, based, for example, on any one or more of suitable known theories and/or studies of economic impact of such environmental impact factors. Another approach specific to greenhouse gases is to calculate a CO2 equivalents metric based on global warming potentials of different pollutant gases. For example, one kilogram of N₂O gas into the atmosphere has been calculated as equivalent to releasing close to 300 kilograms of CO₂ in terms of its global warming potential over 20 years after release.

Though the techniques herein are applicable to any suitable load balancing of requests across data centers and servers within data centers, certain aspects are discussed using load balancing of selecting data centers and/or servers to resolve DNS requests in response to client DNS requests in a GLSB deployment (also referred to herein as load balancing DNS requests) based at least in part on the one or more environmental impact factors as an illustrative example that is non-limiting. Further, in certain aspects, the load balancing of DNS requests may additionally be based on one or more additional parameters, such as a policy, a distance of the client from the data center and/or server, a delay tolerance of the workload associated with the DNS request, a monetary cost associated with the use of the data center and/or server, a current load of the data center and/or server, service level agreement (SLA) requirements of the client, and/or the like.

As noted, though certain aspects are discussed with respect to load balancing of DNS requests in GSLB deployments, it should be noted that such load balancing techniques and accounting for one or more environmental impact factors can be used for similar load balancing of requests across multiple data centers and/or servers, such as for function as a service (FAAS) applications, etc. For example, the load balancing techniques may be used for redirecting or resolving any suitable client request received at a networked load balancer from a client device over a network to a particular data center and/or server based on the techniques discussed herein. Further, though certain aspects are discussed with respect to load balancing to a particular data center, the networked load balancer may similarly load balance to a particular server, for example selecting a particular server in a data center, and not just the data center itself.

The techniques discussed herein improve the functioning of computing systems and solve the technical problem of how to lower carbon footprints while servicing computing tasks across geographically disparate data centers. This improves the functioning of the overall computing system by lowering environmental impact. For example, the load balancing techniques may select data centers for servicing requests that have a lower overall environmental impact.

It should be noted that for the embodiments and aspects discussed herein, reference to selection of a data center for load balancing may entail selection of a specific server within the data center in certain aspects. In certain aspects, the data center is selected based on one or more environmental impact factors and/or one or more additional parameters associated with the data center as discussed, and a server within the data center is selected randomly, using round robin, and/or based on one or more additional parameters specific to the server within the data center. The one or more additional parameters specific to the server may be the same types as discussed herein with respect to the data centers. Further, in certain such aspects, where the embodiments and aspects discuss selection of the data center based on one or more environmental impact factors and/or one or more additional parameters associated with the data center, a particular server may instead be selected based on one or more environmental impact factors and/or one or more additional parameters specific to the server.

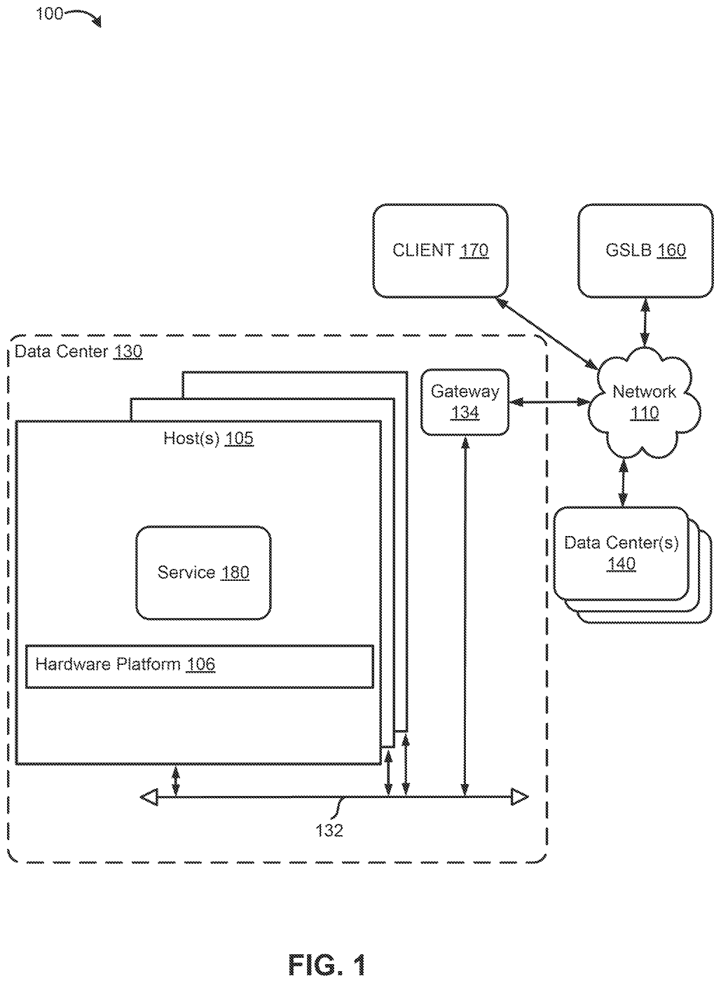

FIG. 1 is an illustration of example network components with which embodiments of the present disclosure may be implemented.

Networking environment 100 includes data center 130 connected to network 110. Network 110 is generally representative of a network of machines such as a local area network (“LAN”) or a wide area network (“WAN”), a network of networks, such as the Internet, or any connection over which data may be transmitted.

Data center 130 generally represents a set of networked machines. Data center 130 includes host(s) 105, a gateway 134, and a data network 132, which may be a Layer 3 network. Host(s) 105 may be an example of machines.

One or more additional data centers 140 are connected to data center 130 via network 110, and may include components similar to those shown and described with respect to data center 130. Communication between the different data centers may be performed via gateways associated with the different data centers.

Each of hosts 105 may include a server grade hardware platform 106, such as an x86 architecture platform. For example, hosts 105 may be geographically co-located servers on the same rack or on different racks. Hardware platform 106 may include one or more of a processor, memory, storage, and networking resources. In certain aspects, one or more virtual computing instances may run on hosts 105, such as virtual machines, containers, etc.

In certain aspects, each of one or more hosts 105 in data center 130 and one or more additional data centers 140, runs an instance of a service 180 configured to provide a server side function to fulfill a client based request as part of a client-server service model. For example, the service could by a web-based service, such as serving a web page to a client. The service 180 may run directly on host 105, such as on an operating system of host 105, or in a virtual computing instance running on a host 105.

Gateway 134 provides components in data center 130 with connectivity to network 110, and is used to communicate with destinations external to data center 130.

GSLB 160 is a GSLB device coupled to network 110. GSLB 160 is configured to perform load balancing functions according to aspects discussed herein. GSLB 160 may comprise a physical machine, similar to host 105, or a virtual computing instance running on a physical machine. It should be noted that though GSLB 160 is described as an example load balancer for DNS request load balancing, any suitable load balancer may be used that can handle the particular type of client requests depending on the use case of the techniques discussed herein.

Client 170 is a client device coupled to network 110. Client 170 is configured to issue requests for services according to aspects discussed herein. Client 170 may comprise a physical machine, similar to host 105, or a virtual computing instance running on a physical machine.

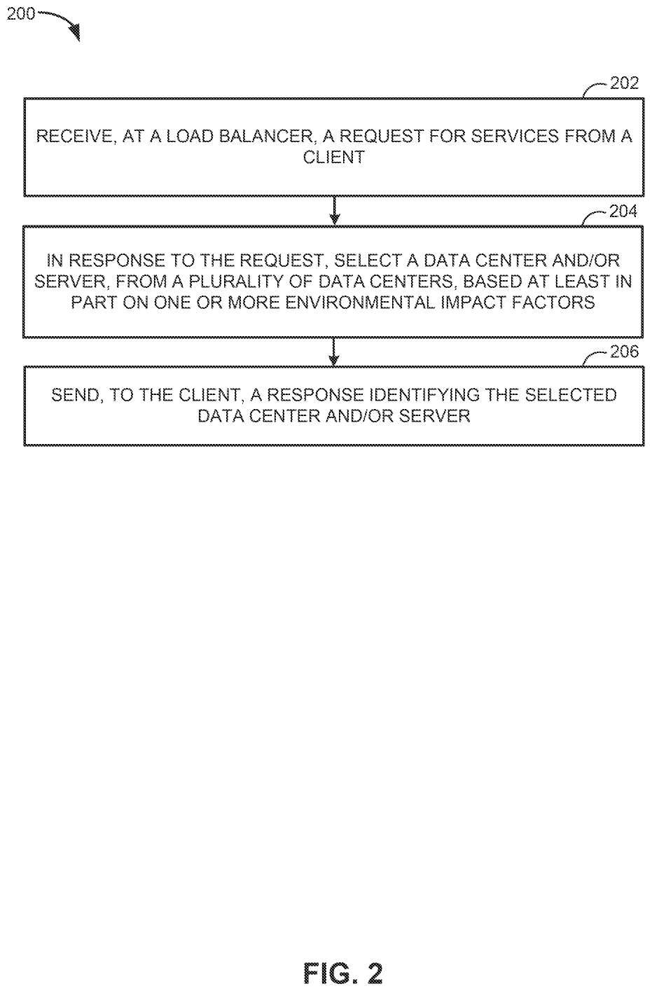

FIG. 2 depicts example operations 200 related to green load balancing across data centers and/or servers. For example, operations 200 may be performed by one or more components of FIG. 1.

Operations 200 begin at step 202, with receiving, at GSLB 160, a request for services from client 170 over network 110. In certain aspects, the request is a DNS request requesting an IP address corresponding to a hostname.

At step 204, in response to the request, GSLB 160 selects a data center (or particular server) among a plurality of data centers (or servers) based on at least one or more environmental impact factors associated with each of the plurality of data centers (or servers). For example, the GSLB 160 may select an IP address associated with the data center, such as of a server in the data center, to resolve a hostname indicated in the DNS request, such that the client further communicates with the selected data center and/or server when making requests associated with the hostname. In other examples, the GSLB 160 selects a data center and/or server to service the request itself, such as where the request is to perform a particular function. For example, GSLB 160 may store information about a plurality of data centers 130/140, such as of servers within the data center, that each run an instance of a service 180 associated with the hostname or configured to provide the requested service. The information may include one or more addresses (e.g., IP address of servers) associated with each of the plurality of data centers, and one or more environmental impact factors associated with each of the plurality of data centers and/or servers.

In certain aspects, GSLB 160 is configured to select a data center and/or server from the plurality of data centers and/or servers that has a minimum environmental impact, or that meets a threshold environmental impact. As discussed, where multiple environmental impact factors are considered, an overall score based on the multiple environmental impact factors may be calculated and used as indicative of the environmental impact. In certain cases, depending on calculation, a minimum overall score may be indicative of lowest environmental impact. In certain cases, depending on calculation, a maximum overall score may be indicative of lowest environmental impact. For example, where the environmental impact factor comprises a CI, the lower the CI, the less the environmental impact. Accordingly, in certain aspects, GSLB 160 selects the data center and/or server from the plurality of data centers that has the lowest CI.

In certain aspects, GSLB 160 may request and receive, over network 110, information regarding the one or more environmental impact factors for the plurality of data centers and/or servers from another computing device storing such information (not shown). As discussed, the one or more environmental impact factors for the plurality of data centers and/or servers may be based on the geographical region where the data centers and/or servers are located.

In certain aspects, GSLB 160 requests and receives the information regarding the one or more environmental impact factors on demand, such as in response to receiving the request for services. In certain aspects, GSLB 160 requests and receives the information regarding the one or more environmental impact factors if a time limit has been passed since the information regarding the one or more environmental impact factors was last received, such as in response to receiving the request for services. For example, if a request for services is received at GSLB 160, and the time limit is 5 minutes, and the latest information regarding the one or more environmental impact factors was last received by GSLB 160 less than 5 minutes prior, the previously received information regarding the one or more environmental impact factors is used by GSLB 160 to select a data center. In the example, if the latest information regarding the one or more environmental impact factors was last received by GSLB 160 more than 5 minutes prior, the GSLB 160 requests and receives updated information regarding the one or more environmental impact factors to select a data center. In certain aspects, GSLB 160 periodically requests and receives the information regarding the one or more environmental impact factors. In certain aspects, the one or more environmental impact factors for a particular data center are not expected to change drastically across small amounts of time. Accordingly, in some aspects, a periodicity of 5 minutes may be used.

In certain aspects, GSLB 160 is configured to select a data center and/or server from the plurality of data centers based on the one or more environmental impact factors for each data center and/or server as well as based on one or more additional parameters associated with each data center and/or server as discussed. For example, the overall score may be calculated for each data center and/or server based on the associated one or more environmental impact factors and the one or more additional parameters, and the overall score of each data center and/or server may be used to select the data center and/or server, such as if the overall score meets one or more criteria, examples of which are discussed further herein.

In an example, the one or more additional parameters include a distance between the client device 170 and each data center and/or server. The GSLB 160 may determine the location of each of client device 170 and each data center and/or server based on GPS information provided by each, or by address information (e.g., IP address information) that the GSLB 160 maps to geographic location based on mapping tables. In an example, the overall score may be calculated according to the following equation:

Overall scoreᵢ=λ₁*CIᵢ+λ₂*distᵢ (1)

Where overall score, is the overall score associated with data center and/or server i, where there may be n data centers and/or servers GSLB 160 selects from to service requests of a particular type;
λ₁ and λ₂ are tunable parameters which reflect the importance assigned to the parameters CI and dist;
CIᵢ is the CI associated with data center and/or server i; and
distᵢ is the distance between data center and/or server i and client 170.

In certain aspects, GSLB 160 is configured to select the data center and/or server i with the lowest overall score (e.g., using equation (1) or maximum or minimum based on any other suitable equation based on any suitable set of parameters), or a data center and/or server i that meets a criteria such as a threshold overall score. In certain aspects, as equation (1) takes into account both distance and environmental impact, equation (1) can balance between latency for servicing requests based on communication latency over a network being larger for greater distances and environmental impact.

In certain aspects, GSLB 160 may calculate a score based on the one or more additional parameters, and select a data center and/or server i with a best calculated score that also satisfies a threshold environmental impact factor. For example, GSLB 160 may be configured with a threshold CI, and may calculate a score based on the one or more additional parameters for those data centers and/or servers that have a CI below the threshold. The GSLB 160 may then select a data center and/or server among those for which a score is calculated having a best score (e.g., minimum or maximum depending on the equation used).

In certain aspects, GSLB 160 may calculate a score based on the one or more environmental impact factors, and select a data center and/or server i with a best calculated score that also satisfies threshold(s) for the one or more additional parameters. For example, GSLB 160 may be configured with one or more thresholds corresponding to one or more additional parameters. For example, a client may require a threshold latency, threshold cost, or threshold for another parameter. Accordingly, GSLB 160 may calculate a score based on one or more environmental impact factors for those data centers and/or servers that satisfy the threshold(s) for the one or more additional parameters. The GSLB 160 may then select a data center and/or server among those for which a score is calculated having a best score (e.g., minimum or maximum depending on the equation used).

In certain aspects, GSLB 160 is configured to select multiple data centers and/or servers of the plurality of data centers based on the one or more environmental impact factors (and optionally one or more additional parameters) such as a best X percentage of the plurality of data centers or servers according to any of the ranking techniques discussed herein. In certain aspects, GSLB 160 may then load balance received requests among the selected multiple data centers and/or servers, such as using round robin or other suitable techniques, so as to ensure no one data center and/or server is overloaded.

In certain aspects, GSLB 160 tracks loading of a data center and/or server based on data center and/or server selection in response to requests, and factors such load of each data center and/or server as an additional parameter. For example, should a data center and/or server be selected in response to a threshold number of requests within a time window (e.g., last 5 minutes), it may not be considered for another request until after it has been selected for less than the threshold number of requests within the time window.

At step 206, GSLB 160 sends a response to client 170 identifying the selected data center and/or server. For example, GSLB 160 sends to client 170 a DNS response message including an IP address associated with the selected data center, such as a server in the selected data center, or of the selected server. Accordingly, client 170 may send requests for the service to the selected data center using the IP address.

Though certain aspects are discussed with respect to GSLB 160 sending a response to client 170, for other types of requests for services, GSLB 160 may itself redirect the request to the selected data center and/or server in a redirected message, and the selected data center and/or server may respond to client 170, such as with a message identifying the address of the selected data center and/or server and/or including a response to the request.

In certain aspects, client 170 may be configured with a limited DNS time to life to ensure that client 170 sends an updated DNS request after a threshold time period, such as to receive selection of a different data center and/or server in a DNS response if one or more environmental impact factors and/or other parameters have changed.

In certain aspects, the techniques herein can lead to additional potentially beneficial results. In particular, auto-scaling logic may be enabled in the data centers discussed herein. The auto-scaling logic may automatically enable (e.g., spawn, spin up, start up, etc.) or shut down servers from a pool of servers based on the load and the load-serving capacity of the servers in the data center. By load balancing requests to greener data centers, less requests are serviced by a less-green datacenter (e.g., DC1) and instead are serviced by a greener datacenter (e.g., DC2). Thus, auto-scaling ends up shutting down/servers/service engines in DC1 and enabling new servers/service-engines in DC2, thereby further reducing the overall environmental impact.

In certain aspects, the carbon usage and/or carbon savings and/or environmental impact reduction achieved using the techniques discussed herein may be calculated based on data exported from GSLB 160 and/or the servers and data centers, and visualized to, for example an administrator. For example, the data may be exported to an administration device accessible on network 110.

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs) --CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system—level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

1. A method of load balancing requests among data centers, comprising:
receiving, at a load balancer from a client, a Domain Name System (DNS) request for a hostname;
selecting, by the load balancer, a first IP address associated with a first data center of a plurality of data centers associated with the hostname based on one or more environmental impact factors associated with each of the plurality of data centers; and
sending, by the load balancer, to the client, a DNS response message indicating the first IP address.

2. The method of claim 1, wherein the one or more environmental impact factors comprise a carbon intensity.

3. The method of claim 1, wherein selecting the first IP address associated with the first data center is further based on one or more additional parameters associated with each of the plurality of data centers, the one or more additional parameters comprising one or more of:
a corresponding latency associated with each of the plurality of data centers,
a delay tolerance of the client,
a corresponding distance between the client and each of the plurality of data centers,
a corresponding monetary cost associated with each of the plurality of data centers, or
a corresponding current load of each of the plurality of data centers.

4. The method of claim 1, wherein selecting the first IP address associated with the first data center comprises:
calculating, for each of the plurality of data centers, an overall score based on the one or more environmental impact factors; and
selecting the first IP address associated with the first data center based on the first data center having a first overall score that satisfies a criteria.

5. The method of claim 4, wherein the overall score is further based on one or more additional parameters.

6. The method of claim 4, wherein the criteria comprises a maximum or minimum overall score.

7. The method of claim 4, wherein the criteria comprises a threshold overall score.

8. The method of claim 1, wherein selecting the first IP address associated with the first data center comprises selecting the first IP address associated with a server within the first data center.

9. The method of claim 8, wherein selecting, by the load balancer, the first IP address associated with the first data center based on the one or more environmental impact factors associated with each of the plurality of data centers comprises selecting the first IP address associated with the server based on one or more environmental impact factors associated with each of a plurality of servers within the plurality of data centers.

10. A computing device configured to load balance requests among data centers, comprising:
at least one memory; and
at least one processor coupled to the at least one memory, the at least one memory and the at least one processor configured to:
receive, from a client, a service Domain Name System (DNS) request for a hostname;
select a first IP address associated with a first data center of a plurality of data centers associated with the hostname based on one or more environmental impact factors associated with each of the plurality of data centers; and
send, to the client, a DNS response message indicating the first IP address.

11. The computing device of claim 10, wherein the one or more environmental impact factors comprise a carbon intensity.

12. The computing device of claim 10, wherein selecting the first IP address associated with the first data center is further based on one or more additional parameters associated with each of the plurality of data centers, the one or more additional parameters comprising one or more of:
a corresponding latency associated with each of the plurality of data centers,
a delay tolerance of the client,
a corresponding distance between the client and each of the plurality of data centers,
a corresponding monetary cost associated with each of the plurality of data centers, or
a corresponding current load of each of the plurality of data centers.

13. The computing device of claim 10, wherein selecting the first IP address associated with the first data center comprises:
calculating, for each of the plurality of data centers, an overall score based on the one or more environmental impact factors; and
selecting the first IP address associated with the first data center based on the first data center having a first overall score that satisfies a criteria.

14. The computing device of claim 13, wherein the overall score is further based on one or more additional parameters.

15. The computing device of claim 13, wherein the criteria comprises a maximum or minimum overall score.

16. The computing device of claim 13, wherein the criteria comprises a threshold overall score.

17. The computing device of claim 10, wherein selecting the first IP address associated with the first data center comprises selecting the first IP address associated with a server within the first data center.

18. The computing device of claim 17, wherein selecting the first IP address associated with the first data center based on the one or more environmental impact factors associated with each of the plurality of data centers comprises selecting the first IP address associated with the server based on one or more environmental impact factors associated with each of a plurality of servers within the plurality of data centers.

19. A non-transitory computer readable medium comprising instructions, which when executed by a computing device, causes the computing device to perform a method of load balancing requests among data centers, the method comprising:
receiving, at a load balancer from a client, a Domain Name System (DNS) request for a hostname;
selecting, by the load balancer, a first IP address associated with a first data center of a plurality of data centers associated with the hostname based on one or more environmental impact factors associated with each of the plurality of data centers; and
sending, by the load balancer, to the client, a DNS response message indicating the first IP address.

20. The non-transitory computer readable medium of claim 19, wherein the one or more environmental impact factors comprise a carbon intensity.

21. The method of claim 1, wherein the DNS response message is associated with a threshold time period, and further comprising:
receiving, at the load balancer from the client, after the threshold time period after sending the DNS response message, a second DNS request for the hostname;
selecting, by the load balancer, a second IP address associated with a second data center of the plurality of data centers associated with the hostname based on one or more updated environmental impact factors associated with each of the plurality of data centers; and
sending, by the load balancer, to the client, a second DNS response message indicating the second IP address.
